(19) United States
(12) Patent Application Publication
(10) Pub. No.: US 2025/0296016 A1
(43) Pub. Date: Sep. 25, 2025

(54) GAS-LIQUID SEPARATION

(71) Applicant: SAUDI ARABIAN OIL COMPANY, Dhahran (SA)

(72) Inventors: Rayan Alrabaei, Jeddah (SA); Mohamed Nabil Noui-Mehidi, Dhahran (SA)

(73) Assignee: SAUDI ARABIAN OIL COMPANY, Dhahran (SA)

(21) Appl. No.: 18/609,827

(22) Filed: Mar. 19, 2024

(51) Int. Cl. B01D 19/00

(52) U.S. Cl. CPC B01D 19/0057; B01D 19/0068; B01D 2257/702

(57) ABSTRACT

A system for conditioning a feed stream that may include a feed inlet, a cycloid pipe, a tangential inlet pipe, and a main pipe, wherein the main pipe and the cycloid pipe may be fluidly connected. The feed inlet may be configured to receive a feed stream including multiphase fluids.

### FIELD OF THE DISCLOSURE

Embodiments of the present disclosure generally relate to devices, systems, and processes for separating multiphase hydrocarbon streams.

### BACKGROUND

Separation of multiphase hydrocarbon streams in hydrocarbon processing is a problem faced by almost all oil and gas and petrochemical operators within the upstream, midstream, and downstream processing stages. Gas-liquid flow separators are commonly used amongst upstream oil and gas operators to separate multiphase hydrocarbon streams into liquid and gas streams. Particularly, an initial separation of wellsite hydrocarbon production, occurring at a wellsite onshore or on a production platform offshore, may include the use of traditional gas-liquid flow separators. Traditional gas-liquid flow separators may be horizontally configured, vertically configured, and may include level indication for produced water and other hydrocarbon liquids.

### SUMMARY OF THE CLAIMED EMBODIMENTS

In one aspect, embodiments disclosed herein relate to the separating or the conditioning of a feed stream. The feed stream may include multiphase fluids. Additionally, the feed stream may include hydrocarbons. This disclosure presents, in accordance with one or more embodiments, processes, systems, and apparatuses for separating a feed stream.

In another aspect, the apparatus may be a conditioning apparatus that may include a feed inlet; a cycloid pipe fluidly connected to the feed inlet; a main pipe wherein the cycloid pipe and main pipe are fluidly connected, wherein the cycloid pipe rotates about the main pipe at elevations between the feed outlet and the tangential inlet pipe, and wherein a cycloid pipe rotation is a 360-degree rotation of the cycloid pipe around the main pipe. The conditioning apparatus may include a tangential inlet pipe disposed at a connection between the cycloid pipe and the main pipe, wherein the cycloid pipe fluidly connects the feed inlet to the tangential inlet pipe. The conditioning apparatus may also include a gas outlet disposed above the tangential inlet pipe and fluidly connected to the main pipe and a liquid outlet disposed below the tangential inlet pipe and fluidly connected to the main pipe. Finally, the conditioning apparatus may include one or more baffle plates disposed within the main pipe and below the tangential inlet pipe.

The system may include a feed inlet configured to receive a feed stream comprised of multiphase fluids. The system may also include a cycloid pipe including the feed stream fluidly connected to an inlet feed, wherein the cycloid pipe is configured to precondition a multiphase fluid. The system may include a tangential inlet pipe comprising the feed stream fluidly connected to the cycloid pipe, wherein the tangential inlet pipe is configured to introduce the feed stream into a main pipe with minimal disturbance in fluid flow, and wherein the tangential inlet pipe is connected to the feed inlet by the cycloid pipe. Finally, the system may include a main pipe which may include the following: a preconditioned feed stream fluidly connected to the tangential inlet pipe, a gas fraction of the feed stream collected at a gas outlet disposed above the tangential inlet pipe and fluidly connected to the main pipe wherein the main pipe disposed above the tangential inlet pipe is configured for a disengagement of the gas fraction from a liquid fraction, a liquid fraction of the feed stream collected at a liquid outlet disposed below the tangential inlet pipe fluidly connected to the main pipe wherein the main pipe disposed below the tangential inlet pipe is configured for collection of the liquid fraction, one or more baffle plates disposed below the tangential inlet pipe fluidly connected to the main pipe configured to prevent the gas fraction from traveling downwards, and wherein the main pipe and the cycloid pipe are fluidly connected.

In another aspect, embodiments disclosed herein relate to a process for separating phases of a feed stream. The process may include separating a feed stream by flowing a feed stream into a cycloid pipe, injecting the feed stream into a tangential inlet pipe fluidly connected to a main pipe, flowing the feed stream from the tangential inlet pipe to the main pipe wherein the main pipe contains a disengagement zone, flowing the feed stream across one or more baffle plates in the disengagement zone wherein a gas fraction flows upward to a gas outlet and a liquid fraction flows downward to a liquid outlet, collecting the liquid fraction at the liquid outlet, and collecting the gas fraction at the gas outlet.

The combination of the cycloid pipe and the main pipe may provide for the separation of feed streams more optimally than does separation by the cycloid pipe or the main pipe alone. Other aspects and advantages will be apparent from the following description and the appended claims.

### BRIEF DESCRIPTION OF DRAWINGS

FIG. 1A illustrates a side view of the conditioning apparatus according to one or more embodiments disclosed herein.

FIG. 1B illustrates a three-dimensional view of the tangential inlet pipe cross-section according to one or more embodiments disclosed herein.

FIG. 2 illustrates a process of conditioning a multiphase hydrocarbon stream according to one or more embodiments disclosed herein.

FIG. 3 illustrates one or more baffle plates with perforations according to one or more embodiments disclosed herein.

FIG. 4 illustrates one or more baffle plates with slots and fins according to one or more embodiments disclosed herein.

### DETAILED DESCRIPTION

“Feed stream,” is a multiphase hydrocarbon stream fed to the conditioning apparatus and includes hydrocarbon multiphase fluids in the liquid and vapor phase.

“Liquid fraction” is the liquid phase separated from the multiphase hydrocarbon stream and evolving from the “liquid outlet” of the conditioning apparatus.

“Gas fraction” is the gas phase separated from the multiphase hydrocarbon stream and evolving from the “gas outlet” of the conditioning apparatus.

“Tangential inlet pipe” is the connecting pipe between the cycloid pipe and the main pipe and is designed to reduce as much as possible the disturbances in fluid flow that may arise when the multiphase hydrocarbon stream flows from the cycloid pipe to the main pipe.

One possible feed stream requiring separation is one that is predominately in the gas phase, being mostly methane and ethane, with up to 25 mol % of the stream including of any components larger in molecular mass than methane and ethane. The feed stream may originate from a well, or a plurality of wells, before the first inlet separator, or downstream of the first inlet separator on an onshore wellpad or on an offshore production platform. The feed stream may additionally be downstream of an onshore wellpad or offshore production platform but upstream of midstream processing, for example at a central collection point.

The present disclosure relates to the separation of a gas fraction from a liquid fraction in a feed stream by utilizing a conditioning apparatus that includes a feed inlet, a cycloid pipe, a main pipe, a tangential inlet pipe, a gas outlet, a liquid outlet, and one or more baffle plates. The present disclosure also relates to a process of separating a gas fraction from a liquid fraction in a feed stream by flowing the multiphase fluid through a cycloid pipe, injecting the multiphase fluid into a tangential inlet pipe connected to a main pipe and utilizing centrifugal forces to carry out the separation. While in the main pipe, gravity is utilized to hydraulically separate the liquid fraction from the gas fraction. The separated liquid fraction collects at a liquid outlet downstream of one or more baffle plates in the main pipe, and gas fraction collects at the gas outlet of the main pipe. The present disclosure also relates to a system of conditioning feed streams utilizing a feed inlet, cycloid pipe, a tangential inlet pipe, a main pipe, a gas outlet, one or more baffle plates, and a liquid outlet.

In one or more embodiments, the feed stream may include methane, ethane, propane, and any components greater in molecular weight than propane. In another embodiment, the feed stream may include nitrogen, hydrogen sulfide, carbon dioxide, and produced water. In some embodiments, the heavier components may include any isomer of butane, pentane, hexane, heptane, octane, nonane, decane, undecane, dodecane, tridecane, tetradecane, pentadecane, cetane (hexadecane), heptadecane, octadecane, nonadecane, and eicosane. In other embodiments, the heavier components may include any isomer of components with molecular weights greater than eicosane.

In one or more embodiments, up to 25 mol % of the feed stream may be components heavier than methane and ethane. Further, up to 25 mol % of the feed stream may be any isomer of hydrocarbons with four or more carbon atoms including but not limited to butane, pentane, hexane, heptane, octane, nonane, decane, undecane, dodecane, tridecane, tetradecane, pentadecane, cetane (hexadecane), heptadecane, octadecane, nonadecane, eicosane, and components with greater molecular weights than eicosane.

Disclosed is a conditioning apparatus that includes a feed inlet connected to a cycloid pipe, which is connected to a downstream main pipe. The connecting pipe between the cycloid pipe and the main pipe is referred to as the tangential inlet pipe. The tangential inlet pipe can be configured to, without substantial disturbance, introduce a fluid tangentially from the cycloid pipe to the main pipe. In some embodiments, the diameter of the feed inlet may be the same as the diameter of the cycloid pipe. In other embodiments, the diameter of the feed inlet may be larger than the diameter of the cycloid pipe. In some embodiments, the diameter of the tangential inlet pipe may be the same as the diameter of the cycloid pipe. In other embodiments, the diameter of the tangential inlet pipe may be larger than the diameter of the cycloid pipe. In some embodiments, the diameter of the tangential inlet pipe may be the same as the diameter of the feed inlet. In other embodiments, the diameter of the tangential inlet pipe may be larger or smaller than the diameter of the feed inlet.

In one or more embodiments, the cycloid pipe may rotate about a main pipe between 1 and 12 times, or 1 and 12 cycloid pipe rotations, where a cycloid pipe rotation is a 360-degree rotation of the cycloid pipe around the main pipe. In one embodiment, the cycloid pipe may encircle the main pipe 3 to 6 times. In one or more embodiments, the cycloid pipe rotations may be inclined 1 to 15 degrees from a reference horizontal line normal to a vertical axis of the main pipe.

In one or more embodiments, the cycloid pipe may have of a plurality of elbows. For example, the cycloid pipe may include elbows of 22.5 degrees, 30 degrees, 45 degrees, 90 degrees. The cycloid pipe may include long-radius elbows, short-radius elbows, and reducing elbows, alone or in combination. A long-radius elbow may include but is not limited to an elbow with a center-to-end length of 1.5 times the nominal pipe size (NPS) whereas a short-radius elbow is an elbow with a center-to-end length of 1 times the nominal pipe size, where the diameter of the elbow is constant. A reducing elbow may include but is not limited to an elbow which has two different diameters. A long radius reducing elbow may include but is not limited to a reducing elbow where the center-to-end length is 1.5 times the larger diameter NPS. A short radius reducing elbow may include but is not limited to a reducing elbow where the center-to-end length is 1.0 times the larger diameter NPS. The cycloid pipe may include elbows of all the same angles or a plurality of varying angles. In one or more embodiments, the cycloid pipe may include a plurality of elbows fastened in a plurality of ways such as via welding, flanging, or fastening in a way allowing for an operating pressure rating of between 740 psig and 15,000 psig, or may be created by conventional pipe bending equipment or other suitable pipe shaping techniques. In an embodiment where the cycloid includes tubing, the tubing may be wound into the desired configuration and secured. In another embodiment where the cycloid pipe has multiple individual pipe sections, such as individual pipe sections utilizing flanges, a replacement of any pipe section may be more easily carried out than the replacement of one continuous tubing section.

The selection of elbows may be made so as to provide for an inclination from a reference horizontal line normal to a vertical axis of the main pipe. The inclination from the reference horizontal line normal to the vertical axis of the main pipe may be between 1 and 15 degrees. The cycloid pipe and the main pipe are connected via a tangential inlet pipe, where downstream of the tangential inlet pipe, the cycloid pipe may be angled at 1 to 15 degrees from the reference horizontal normal to the vertical axis of the main pipe. The main pipe is a vertically straight pipe normal to horizontal plane and may be connected to a liquid outlet and a gas outlet. The gas outlet may be connected to the top of the main pipe. The liquid outlet may be connected to the bottom of the main pipe.

In one embodiment, the main pipe and the cycloid pipe may have the same diameter. In another embodiment, the main pipe and the cycloid pipe may have different diameters. In one or more embodiments, the main pipe may have a diameter between 1 and 13 times the diameter of the cycloid pipe. In one or more embodiments, the diameter of the cycloid pipe and the diameter of the main pipe may be between 2 inches and 108 inches. In one embodiment, the cycloid pipe path diameter may be three times that of the main pipe diameter. These dimensions are adjustable according to whether a smaller or larger cycloid pipe is needed with respect to the main pipe, provided the configuration is designed to reduce disturbances of the multiphase fluid flowing from the cycloid pipe to the main pipe at the tangential inlet pipe.

In one or more embodiments, the main pipe diameter may be uniform from the top at the gas outlet and the bottom at the liquid outlet. The main pipe may alternatively include an expansion in diameter towards the liquid outlet, wherein the liquid outlet diameter is between one and five greater than the rest of the main pipe diameter. This expansion in diameter may be facilitated by way of a pipe reducer, flanged, welded, or fastened in a way that allows for the pressure rating of 740 psig and 15,000 psig.

In one or more embodiments, the liquid outlet may include one or more baffle plates placed 1 to 20 main pipe diameters below the tangential inlet pipe fluidly connected to both the main pipe and the cycloid pipe. The one or more baffle plates may include perforations of a diameter sufficient to prevent gas carry-under into the liquid outlet. One or more baffle plates may include a circular plate covering 100% of the cross-sectional area of the main pipe. In one or more embodiments, one or more baffle plates may include one or more baffles in a semi-circle shape covering between 30% and 40%, 40% and 50%, 50% and 60%, 60% and 70%, 70% and 80%, 80% and 90%, and 90% to 100% of the main pipe area. In one or more embodiments, one or more baffle plates may include cross-flow baffles. In one or more embodiments, one or more baffle plates may include baffles with six or more fins. In one or more embodiments, one or more baffle plates may include the same material as that of the main pipe material for simplicity or any other material unreactive with the treated fluids, including any polymer, composite, or metal material.

In one or more embodiments, the conditioning apparatus components may be composed of materials strong enough to withstand pressure between 740 psig and 15,000 psig. The feed inlet, cycloid pipe, main pipe, liquid outlet, one or more baffle plates, and gas outlet may constructed of any variety of carbon steel, stainless, steel, fiberglass, composite materials, and any material strong enough to withstand pressure between 740 psig and 15,000 psig. The cycloid pipe and the main pipe may include materials fastened together either by welding, flanging, or by mechanical pipe-forming techniques. One or more baffle plates may include any material strong enough to withstand static pressures of 740 psig to 15,000 psig and a flow rate of up to 10 MMSCFD at the feed inlet.

The system for separating feed streams containing one or more hydrocarbons disclosed herein may include a feed inlet, a cycloid pipe, a tangential inlet pipe, a main pipe, a gas outlet, a liquid outlet, and one or more baffle plates. The system may include a feed inlet configured to receive a feed stream that includes a multiphase fluid. In one or more embodiments, the cycloid pipe is configured to precondition the feed stream upstream of injection into a main pipe segment. The cycloid pipe may precondition the feed stream because the cycloid pipe may at least begin to partially separate the liquid fraction from the vapor fraction prior to entering the main pipe. The cycloid pipe may cause the multiphase fluid to travel in a path that promotes further separation and reduced disturbance once introduced into the main pipe. Size and configuration of the cycloid pipe may affect the processing of the feed stream. For example, a larger number of cycloid pipe rotations may provide for a shorter time the feed stream spends in the main pipe to lead to the same level of separation. Finally, the distance between successive rotations may vary. The higher the number of cycloid pipe rotations around the main pipe, the slower the velocity of both the hydrocarbon liquid and vapor phases, and correspondingly the higher degree of phase separation that may occur in the feed stream.

In one or more embodiments, the cycloid path may have constant curvature, or varying curvature, allowing a configuration of the cycloid path where the encircling pipe is at first set at a further distance from the main pipe, and as the cycloid pipe encircles the main pipe further down, the cycloid pipe is closer to the main pipe. In other words, the cycloid pipe may be wound tighter and tighter towards the bottom of the main pipe to reduce the disturbance of the cycloid pipe contents flowing into the main pipe.

In one or more embodiments, the straight tangential inlet pipe may be disposed at an acute angle from the main pipe, where the angle is measured between the tangential inlet pipe and a tangent line off the main pipe circumference, where the tangent line is measured from a tangent point disposed at the connection between the tangential inlet pipe and the main pipe. In one or more embodiments the acute angle may be between 0 and 90 degrees, 20 and 90 degrees, and between 60 and less than 90 degrees. In one or more embodiments, the acute angle may be less than or equal to 90 degrees.

In some embodiments, the tangential inlet pipe may instead be a tangential inlet point. For example, instead of a tangential inlet pipe disposed between the main pipe and the cycloid pipe, there may instead just be a direct connection between the main pipe and the cycloid pipe. In this embodiment, the acute angle at the tangential inlet between the cycloid pipe and the main pipe depends on how far the cycloid pipe is from the main pipe and how tightly wound the cycloid pipe is around the main pipe. Finally, the acute angle may be as high as 90 degrees or any angle that provides for minimal disturbance of the fluid at the tangential inlet pipe.

As the feed fluid flows around the cycloid pipe and centrifugal forces act on the multiphase fluid, the dense liquid fraction may tend to migrate along and spray a film evenly along the outer walls and the less dense gas fraction may tend to flow along the inner walls of the cycloid pipe. The “inner” walls in this scenario are the walls of the cycloid pipe that are closer to the main pipe and the “outer” walls are the walls of the cycloid pipe that are further from the main pipe. Additionally, the higher the number of rotations the cycloid pipe makes, the slower the speed of the multiphase fluid, and the lower any potential wear on the main pipe. Finally, the fluid flow in the cycloid pipe may provide for minimal wear in the pipe as the liquid phase of the fluid may flow more slowly along the outer walls of the cycloid path and the vapor phase may flow more quickly along the inner walls of the cycloid path.

As the multiphase fluid travels through the cycloid pipe, further experiencing centrifugal forces separating the liquid from the vapor phase, and further entering the tangential inlet pipe and the main pipe, the vapor fraction may exit the tangential inlet pipe flowing upwards and the liquid fraction flowing downwards. The tangential inlet pipe may be configured such that the multiphase fluid exiting the cycloid pipe may flow in a flow swirl path within the main pipe that is initially similar to the flow path in the cycloid pipe. Minimal disturbance in the fluid flow in the tangential inlet pipe from the cycloid pipe to the main pipe may allow for greater efficiency of separation and may provide for reduced wear on the internal surfaces of the main pipe. The tangential inlet pipe between the cycloid pipe and the main pipe may be configured such that the outer diameter of the cycloid pipe blends into the inner surface contours of the tangential inlet pipe and the main pipe allowing for a smooth transition. For example, if the diameters of the cycloid pipe, tangential inlet pipe, and the main pipe are not dissimilar, then a smoother transition from cycloid pipe to main pipe may be made such that there is minimal disturbance in the fluid flow from the cycloid pipe to the main pipe, allowing for greater separation efficiency, allowing for less wear on the inner pipe walls.

The feed stream in the cycloid pipe may travel at any velocity sufficient to produce an initial separation of the liquid fraction from the vapor fraction while in the cycloid pipe. The velocity of the fluid in the cycloid pipe may be between 1 ft/s to 100 ft/s. In some embodiments, the fluid may have an average residence time in the conditioning apparatus between 1 second and 1 minute, depending on the size, flow rate, and pressure of the conditioning apparatus.

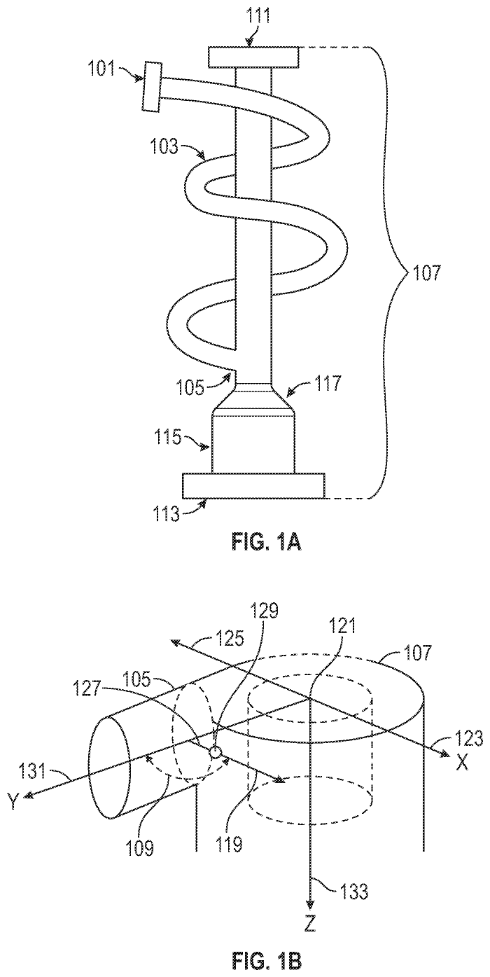

FIG. 1A illustrates a side-view of the conditioning apparatus that includes the feed inlet 101 which receives a feed stream that includes multiphase hydrocarbon fluid. After entry into the feed inlet 101, the feed stream may flow through a cycloid pipe 103 that causes centrifugal forces to separate the liquid fraction from the gas fraction in the feed stream. After flowing through the cycloid pipe 103, the feed stream may enter the tangential inlet pipe 105. At the tangential inlet pipe, the gas phase may then flow upwards to the gas outlet 111 and the liquid phase may flow downwards to the liquid outlet 113. Prior to the exit of the liquid fraction from the liquid outlet 113, the fluid may be processed through one or more baffle plates 115 in order to prevent gas vapors from being carried under with the liquid fraction. Upstream of the one or more baffle plates 115 may be a reducer 117 as shown in the figure.

FIG. 1B illustrates a three-dimensional view of the tangential inlet pipe as labeled in FIB 1A and further illustrated. The feed stream may enter the main pipe 107 through the tangential inlet pipe 105. The tangential inlet pipe 105 may be disposed along a y-axis centered in the tangential inlet pipe, and the main pipe may be disposed along a z-axis centered tangentially in the main pipe. The tangential inlet pipe is disposed in relation to the main inlet pipe at an acute angle of θ 109. The acute angle θ may be defined as the angle between the tangential inlet pipe along the y-axis and the tangent line to the main pipe circumference, which is disposed parallel to the x-axis, where the tangent point 129 of the tangent line is disposed at the connection between the tangential inlet pipe and the main pipe. The positive x-axis is represented by 123, the negative x-axis is represented by 125, the y-axis is represented by 131, the z-axis is represented by 133, and the x, y, and z coordinates of (0, 0, 0) are represented by 121. In one or more embodiments, the tangent line 119 may be disposed at the connection between the tangential inlet pipe and the main pipe which yields the highest positive number on the positive x-axis 123, where the tangent line is connected to an arc 127 drawn from the center of the tangential inlet pipe 105 along the y-axis and mirroring the main pipe curvature.

In one or more embodiments the acute angle may be between 0 and 90 degrees, 20 and 90 degrees, and between 60 and 90 degrees. In one or more embodiments, the acute angle may be less than or equal to 90 degrees. Although not shown in the figure, the tangential inlet pipe may instead be a tangential inlet point, and the acute angle of θ 109 may be defined instead as the angle between the main pipe and the cycloid pipe, where the angle θ 109 may depend on how far the cycloid pipe is from the main pipe and how tightly wound the cycloid pipe is around the main pipe.

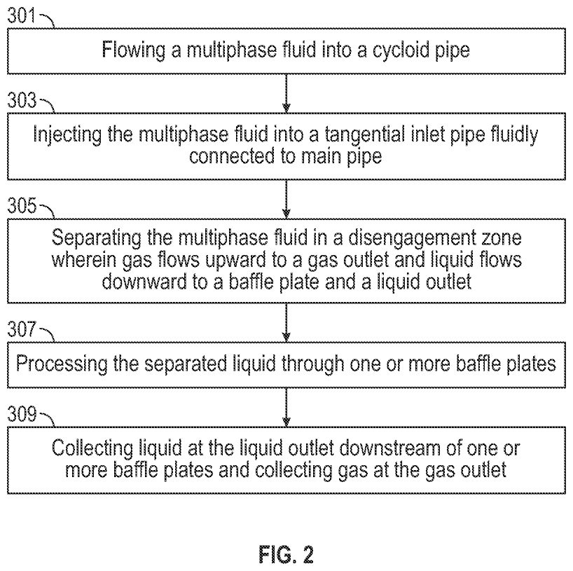

FIG. 2 illustrates a method of conditioning a multiphase fluid in a conditioning apparatus that includes a feed inlet, cycloid pipe, tangential inlet pipe, main pipe, gas outlet, one or more baffle plates, and a liquid outlet. At step 301, a feed stream is introduced into a cycloid pipe. The cycloid pipe preconditions the feed stream which includes multiphase hydrocarbons by causing the feed stream to be further separated by centrifugal forces as applied by the cycloid pipe to the feed stream. After the feed stream has been processed, the feed stream is injected at step 303 into a tangential inlet pipe connected to the main pipe. The acute angle at step 303 may be such that disturbance in the fluid flow from the cycloid to the main pipe is reduced. After the feed stream has been processed in the cycloid pipe, the feed stream is further separated in step 305 wherein the gas phase rises in the portion of the main pipe above the tangential inlet pipe in a disengagement zone, where any remaining liquid fraction can be further separated from the gas fraction and collected at a gas outlet and the liquid fraction may be collected at the liquid outlet at step 309. Additionally in step 307, the falling liquid fraction may contact one or more baffle plates to prevent any gas carry-under.

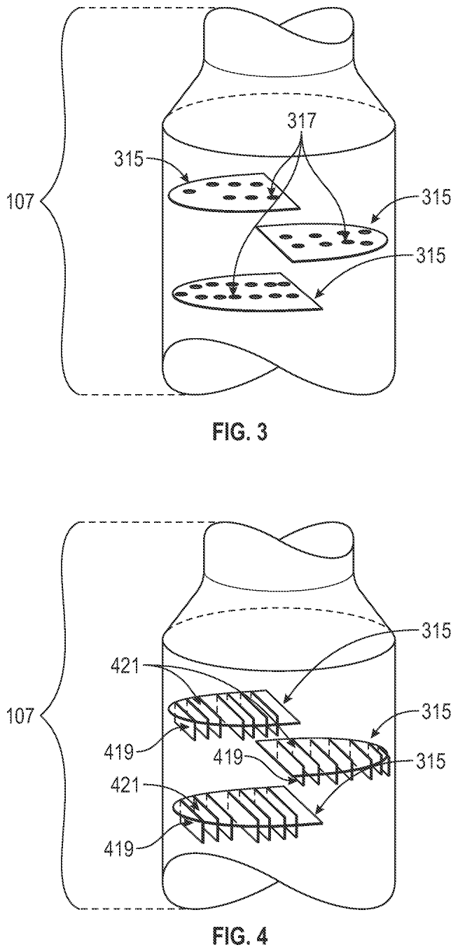

FIG. 3 illustrates one example of one or more cross-flow baffle plates for the section of main pipe 107 disposed below the tangential inlet pipe adjacent to the liquid outlet. FIG. 3 illustrates three baffles 315 that are perforated with baffle perforations 317. While FIG. 3 illustrates three baffles, there is no limit to the number of baffles that may be introduced. While FIG. 3 illustrates spacing between the baffles, and a coverage of the main pipe diameter, it should be understood that the figure in no way imposes limitations on the spacing between the baffles 315, nor does the figure limit the size of the baffles to any degree as a semi-circular or circular shape. While FIG. 3 illustrates a limited number of perforations made in the baffles 315, it should be understood that the figure in no way limits the number, arrangement, uniformity, or size of the perforations made in the baffles 315. The fluid flow mechanism proceeds in FIG. 3 such that liquid fraction falls through the baffle perforations 317 allowing any extra vapor to evaporate from the liquid fraction as the liquid fraction collects at the liquid outlet.

FIG. 4 illustrates one or more baffle plates including baffles with six fins or more for the section of the main pipe disposed below the tangential inlet pipe and the liquid outlet. While FIG. 4 illustrates three baffles 315 and seven fins 419 per baffle, a particular baffle spacing, and a particular slot 421 size, it should be understood that the figure in no way limits the number or spacing of baffles, the number of fins 419, the size of the fins 419, or the slot 421 sizes in the baffle. The fluid flow mechanism in FIG. 4 proceeds such that the liquid fraction falls through the slots 421 and along the baffle fins 419 allowing any extra vapor to evaporate from the liquid fraction as it collects at the liquid outlet.

As outlined above, the present disclosure provides for a conditioning apparatus, and a system and a method of separating a liquid fraction and gas fraction in a feed stream composed of multiphase fluid hydrocarbons. The feed stream may include hydrocarbons, water, and gas. The combination of the cycloid pipe and the main pipe provides separation of multiphase feed streams more optimally than does separation by the cycloid pipe or the main pipe alone.

Finally, it is to be understood that the configurations described above, along with the specific examples and uses are only illustrations of the application of the principles in the present invention. Numerous modifications and variants of the arrangements may be made by those skilled in the art without departing from the spirit and scope of the present disclosure and the appended claims are intended to include such modifications. Thus, while the present invention has been described above with particularity, it will be apparent to those of ordinary skill in the art that numerous modifications, including but not limited to, variations in assembly, size, materials, form, function, and operation may be used without departing from the principles and concepts set forth herein.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “about” is used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed is:

1. A process of separating a feed stream, the process comprising:
flowing a feed stream into a cycloid pipe,
injecting the feed stream into a tangential inlet pipe fluidly connected to a main pipe,
flowing the feed stream from the tangential inlet pipe to the main pipe, wherein the main pipe contains a disengagement zone,
flowing the feed stream across one or more baffle plates in the disengagement zone wherein a gas fraction flows upward to a gas outlet and a liquid fraction flows downward to a liquid outlet,
collecting the liquid fraction at the liquid outlet, and
collecting the gas fraction at the gas outlet.

2. The process of claim 1, wherein the feed stream is a multiphase hydrocarbon mixture comprising of methane, propane, and heavier hydrocarbons.

3. The process of claim 1, wherein the feed stream is a multiphase stream having both the liquid fraction and the gas fraction.

4. The process of claim 1, wherein the feed stream is at a pressure in the range of 740 psig to 15,000 psig.

5. A process of claim 1, wherein the one or more baffle plates has between 1 and 10 baffles.

6. A conditioning apparatus comprising:
a feed inlet;
a cycloid pipe fluidly connected to the feed inlet;
a main pipe,
wherein the cycloid pipe and the main pipe are fluidly connected,
wherein the cycloid pipe rotates about the main pipe at elevations between the feed outlet and the tangential inlet pipe, and
wherein a cycloid pipe rotation is a 360-degree rotation of the cycloid pipe around the main pipe;
a tangential inlet pipe disposed at a connection between the cycloid pipe and the main pipe,
wherein the cycloid pipe fluidly connects the feed inlet to the tangential inlet pipe;
a gas outlet disposed above the tangential inlet pipe and fluidly connected to the main pipe;
a liquid outlet disposed below the tangential inlet pipe and fluidly connected to the main pipe; and
one or more baffle plates disposed within the main pipe and below the tangential inlet pipe.

7. The apparatus of claim 6, wherein a range of cycloid pipe rotations is 1 to 12.

8. The apparatus of claim 6, wherein the acute angle of the tangential inlet pipe is less than 90 degrees from the tangent line to the main pipe circumference, wherein the tangent point is disposed at the connection between the tangential inlet pipe and the main pipe.

9. The apparatus of claim 6, wherein the one or more baffle plates are disposed 1 to 20 main pipe diameters below the tangential inlet pipe.

10. The apparatus of claim 6, wherein the apparatus is rated at a pressure in a range of 740 psig to 15,000 psig.

11. The apparatus of claim 6, wherein a cycloid pipe rotations are 1 to 15 degrees from a horizontal reference normal to a vertical axis of the main pipe.

12. The apparatus of claim 7, wherein the one or more baffle plates include perforations.

13. The apparatus of claim 7, wherein the one or more baffle plates include fins and slots.

14. The apparatus of claim 7, wherein the one or more baffle plates include between 1 and 10 baffles.

15. The apparatus of claim 6, wherein the main pipe has a diameter of between 3 and 13 times a diameter of the cycloid pipe.

16. A system of conditioning a feed stream comprising:
a feed inlet configured to receive a feed stream comprised of multiphase fluids;
a cycloid pipe comprising:
the feed stream fluidly connected to an inlet feed, wherein the cycloid pipe is configured to precondition a multiphase fluid;
a tangential inlet pipe comprising:
the feed stream fluidly connected to the cycloid pipe, wherein the tangential inlet pipe is configured to introduce the feed stream into a main pipe with minimal disturbance in fluid flow, and
wherein the tangential inlet pipe is connected to the feed inlet by the cycloid pipe; and
a main pipe comprising:
a preconditioned feed stream fluidly connected to the tangential inlet pipe,
a gas fraction of the feed stream collected at a gas outlet disposed above the tangential inlet pipe and fluidly connected to the main pipe wherein the main pipe disposed above the tangential inlet pipe is configured for a disengagement of the gas fraction from a liquid fraction,
a liquid fraction of the feed stream collected at a liquid outlet disposed below the tangential inlet pipe fluidly connected to the main pipe wherein the main pipe disposed below the tangential inlet pipe is configured for collection of the liquid fraction,
one or more baffle plates disposed below the tangential inlet pipe fluidly connected to the main pipe configured to prevent the gas fraction from traveling downwards, and
wherein the main pipe and the cycloid pipe are fluidly connected.

17. The system of claim 16, wherein the system is configured to condition a feed stream comprising methane, propane, and heavier hydrocarbons.

18. The system of claim 16, wherein the system is configured to condition a multiphase feed stream having both the liquid fraction and the gas fraction.

19. The system of claim 16, wherein the system is operated at a pressure in a range of 740 psig to 15,000 psig.

20. The system of claim 16, wherein the one or more baffle plates include between 1 and 10 baffles.
